(19) United States
(12) Patent Application Publication
(10) Pub. No.: US 2005/0141739 A1
(43) Pub. Date: Jun. 30, 2005

(54) Soft hearing aid with stainless steel wire

(75) Inventors: Roger P. Juneau, Destrehan, LA (US); Edward J. Desporte, Covington, LA (US); Michael W. Major, Mandeville, LA (US); Gregory R. Siegle, Kenner, LA (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002, US

(73) Assignee: SOFTEAR TECHNOLOGIES, L.L.C. (a Louisiana Limited Liability Company), Harahan, LA (US)

(21) Appl. No.: 10/790,623

(22) Filed: Mar. 1, 2004

Related U.S. Application Data
(60) Provisional application No. 60/456,057, filed on Mar. 20, 2003.
(60) Provisional application No. 60/450,898, filed on Feb. 28, 2003.

(51) Int. Cl. H04R 25/00

(52) U.S. Cl. 381/322; 381/328; 381/324

(57) ABSTRACT

A hearing aid instrument of the in-the-ear type (and preferably CIC) provides a plate member with electronic hearing aid components mounted thereto. The plate member is preferably of a harder material such as hard plastic. A soft polymeric body is bonded to the plate member and encapsulates preferably a plurality of the electronic hearing aid components. The body is soft and is shaped to conform to the ear canal of the user. The soft polymeric body and encapsulated electronic hearing aid components define a soft structure compliant to the ear canal during use and that is substantially solid and free of void spaces between at least some of the components and the ear canal. This combination of soft compliant structure and encapsulated electronic hearing aid components addresses problems of peripheral leakage, poor fit, pivotal displacement that occurs with jaw motion and internal cross talk of components housed in prior art hollow type hearing aids.

### CROSS-REFERENCE TO RELATED APPLICATIONS

Priority of U.S. Provisional Patent Application Ser. No. 60/456,057, filed 20 Mar. 2003, incorporated herein by reference, is hereby claimed.

Priority of U.S. Provisional Patent Application Ser. No. 60/450,898, filed 28 Feb. 2003, incorporated herein by reference, is hereby claimed.

### STATEMENT REGARDING FEDERALLY SPONSORED RESEARCH OR DEVELOPMENT

Not applicable

REFERENCE TO A “MICROFICHE APPENDIX”

Not applicable

### BACKGROUND OF THE INVENTION

1. Field of the Invention

The present invention relates to hearing aids and more particularly to an improved hearing aid and its method of manufacture. More particularly, the present invention provides an improved method for constructing a hearing aid combining a mounting member (for example, a receptacle or face plate) with a soft polymeric body that is joined to the mounting member and which encapsulates one or more of the electronic hearing aid components of the apparatus, the soft polymeric body being sized and shaped to conform to the user's ear canal during use. In one form, a soft polymeric material is used as the face plate. A wiring harness interfaces the electronic hearing aid components. The improved wiring harness is of a multi-strand cable that can be of stainless steel that is plated so that it can be soldered and is insulated with a bio-compatible coating.

2. General Background of the Invention

The hearing industry has realized major strides in the development of high-fidelity, high-performance products, the most recent of which is digital signal processing technology. Hearing care professionals expected those advancements to solve the shortcomings of traditional amplification, and to push the market forward. Those expectations have not been fully realized. While these developments have solved many of the problems associated with traditional electronic design and steadily gained market share, they have not fostered overall market growth.

The issues of early acoustic feedback, less than optimum fidelity and intermodulation of the frequency response cannot be completely resolved by electronic manipulation of the signal by either analog or digital means.

Historically, custom-molded ear worn hearing instruments have been limited to an “acrylic pour” process as the means of the construction. With the advent of miniaturization and technological advancement of computer chip programming, the ear-worn instruments have become smaller and are positioned into the bony portion of the ear canal, commonly referred to as “deep insertion technology”.

Developments outside the hearing industry have culminated in a new level of micro-miniaturization of electronic components for industry applications. Consequently, advanced signal processing can be housed in less space than was required for traditional electro-acoustic components.

With the development of programmable hearing aids, using either analog or digital signal processing, custom electronic design has shifted from the manufacturing level to the clinical level. The clinician can now customize the electro-acoustic response via software. It is no longer necessary for the device to be returned to the manufacturer for hardware changes to arrive at the desired electro-acoustic response. However, it is still often necessary to return the device for shell modifications.

In direct contrast to electronic advances within the industry, little or no advancement has been realized in custom prosthetic design. Since the late 1960's, when the custom in-the-ear hearing aid was developed, materials and construction techniques remained virtually unchanged. These materials and techniques were adopted from the dental industry, whereby the customized housing-commonly called a “shell” was constructed using acrylic of 90 point Durometer Hardness Shore D. This construction process provided the structure and the strength of material necessary to protect the electronics.

At the time the acrylic shell was developed, hearing instruments were worn in the relatively forgiving cartilaginous portion of the ear canal. Micro-miniaturization of electronic components, combined with increased consumer demand for a cosmetically acceptable device, has shifted the placement of the hearing aid toward the bony portion of the ear canal.

The bony portion of the canal is extremely sensitive and intolerant of an acrylic shell when that shell is over sized due to standard waxing procedures or is in contact with the canal wall beyond the second anatomical bend. Rigid acrylic that does not compress must pivot in reaction to jaw or head movement, thereby changing the direction of the receiver yielding a distorted acoustic response. In addition, the pivot action causes displacement of the device resulting in unwanted acoustic feedback. This problem has necessitated countless shell modifications, thereby compromising the precision approach of the original dental technology. Many such devices require some modification by the manufacturer. Most manufacturers can expect a high percentage of returns for modification or repair within the first year. Consequently, CIC (completely in canal) shell design has been reduced to more of a craft than a science. Although the recent introduction of the ultra-violet curing process has produced a stronger, thinner shell, the overall Shore Hardness remained unchanged.

The current trend for custom hearing aid placement is to position the instrument toward the bony portion of the ear canal. The ear canal can be defined as the area extending from the concha to the tympanic membrane. It is important to note that the structure of this canal consists of elastic cartilage laterally, and porous bone medially. The cartilaginous portion constitutes the outer one third of the ear canal. The medial two-thirds of the ear canal is osseous or bony. The skin of the osseous canal, measuring only about 0.2 mm in thickness, is much thinner than that of the cartilaginous canal, which is 0.5 to 1 mm in thickness. The difference in thickness directly corresponds to the presence of apocrine (ceruminous) and sebaceous glands found only in the fibrocartilaginous area of the canal. Thus, this thin-skinned thinly-lined area of the bony canal is extremely sensitive to any hard foreign body, such as an acrylic hearing instrument.

Exacerbating the issue of placement of a hard foreign body into the osseous area of the ear canal is the ear canal's dynamic nature. It is geometrically altered by temporomandibular joint action and by changes in head position. This causes elliptical elongation (widening) of the ear canal. These alterations in canal shape vary widely from person to person. Canal motion makes it very difficult to achieve a comfortable, true acoustic seal with hard acrylic material. When the instrument is displaced by mandibular motion, a leakage or “slit leak” creates an open loop between the receiver and the microphone and relates directly to an electroacoustic distortion commonly known as feedback. Peripheral acoustic leakage is a complex resonator made up of many transient resonant cavities. These cavities are transient because they change with jaw motion as a function of time, resulting in impedance changes in the ear canal. These transients compromise the electroacoustic performance.

The properties of hard acrylic have limitations that require modification to the hard shell exterior to accommodate anatomical variants and the dynamic nature of the ear canal. The shell must be buffed and polished until comfort is acceptable. The peripheral acoustic leakage caused by these modifications results in acoustic feedback before sufficient amplification can be attained.

Hollow shells used in today's hearing aid designs create internal or mechanical feedback pathways unique to each device. The resulting feedback requires electronic modifications to “tweak” the product to a compromised performance or a “pseudo-perfection”. With the industry's efforts to facilitate the fine-tuning of hearing instruments for desired acoustic performance, programmable devices were developed. The intent was to reduce the degree of compromise, but by their improved frequency spectrum the incidence of feedback was heightened. As a result, the industry still falls well short of an audiological optimum.

A few manufacturers have attempted all-soft, hollow shells as alternatives to acrylic, hollow shells. Unfortunately, soft vinyl materials shrink, discolor, and harden after a relatively short period of wear. Polyurethane has proven to provide a better acoustic seal than polyvinyl, but has an even shorter wear life (approximately three months). Silicones have a long wear life but are difficult to bond with plastics such as acrylic, a necessary process for the construction of custom hearing instruments. To date, acrylic has proven to be the only material with long term structural integrity. The fact remains, however, that the entire ear is a dynamic acoustic environment and is ill-served by a rigid material such as acrylic. Also, the acrylic hearing aids typically need to be returned to the manufacturer for major shell modifications.

The following references (as well as all patents and published patent applications listing one or more of the present inventors as an inventor) are all incorporated herein by reference:

U.S. Pat. Nos. 4,051,330; 4,375,016; 4,607,720; 4,716,985; 4,811,402; 4,870,688; 4,880,076; 4,937,876; 5,002,151; 5,068,902; 5,185,802; 5,201,007; 5,259,032; 5,530,763; 5,430,801; 5,500,902; 5,659,621; 6,022,311; 6,432,247; 6,354,990.

A Japanese reference that discusses a hearing aid that features a thin wall soft shell is the Takanishi patent application number 1989-238198.

Also of interest and incorporated herein by reference are published Japanese patent application no. JA61-238198, the articles from December 1997 Journal of American Academy of Audiology, and Staab, Wayne J. and Barry Finlay, “A fitting rationale for deep fitting canal hearing instruments”, Hearing Instruments, Vol. 42, No. 1, 1991, pp. 7-10, 48.

### BRIEF SUMMARY OF THE INVENTION

The present invention provides a method and material for the construction of a soft hearing instrument that is solid (i.e. eliminates void spaces). This instrument includes a soft body portion that is truly soft, comprising an elastomer of about 3 to 55 durometer Shore A and preferably 10-35 durometer Shore A. This product is unique in that it is solid, with the electronic components actually encapsulated or embedded within the soft fill material. The fill material can be a Dow Corning® MDX-4-4210 silicone or a silicone polymer distributed by Factor II, Inc. of Lakeside, Ariz., designated as product name 588A, 588B, 588V.

The present invention provides a method that can replace traditional acrylic shell construction. Unlike the shell construction process, the ear impression is not modified, built up, or waxed. With the elimination of these steps, a more faithful reproduction of the ear impression is accomplished. With the present invention, the manufacturer should be able to produce a hearing aid body which will not need to be returned as frequently for modification as with present hard acrylic hearing aid bodies.

The apparatus of the present invention is virtually impervious to the discoloration, cracking, and hardening experienced with polyvinyls and polyurethanes.

The hearing aid of the present invention provides a greater range of gain before feedback occurs.

The outer surface of the body of the present invention is preferably non-absorbent and virtually impervious to cerumen.

As used herein, “in the ear hearing aids” includes all hearing aids which have all of the electronics positioned in the ear, and thus includes hearing aid styles ranging from full concha to CIC (completely in the canal) hearing aid styles. The preferred embodiment of the present invention shown in the drawings is a CIC hearing aid style.

The present invention provides a wiring harness that interfaces with multiple of the electronic hearing aid components. The wiring harness is preferably a multi-strand or multi wire stainless steel cable that is plated so that it can be soldered.

The multi-strand cable is coated with a bio-compatible insulation such as PTFE, ETFE or other bio-compatible material that is an insulated coating for metallic wires.

The plating can be silver, gold or copper flashing.

The individual wires of the multi-strand wire are preferably plated.

The overall multi-strand wire forms a cable such as a 1 by 7,7 wire cable (though one could practically use anything from 1 by 5 to 1 by 10, as long as the strand is preferably no more than about 0.003 inches (0.0762 mm) uncoated and about 0.005-0.006 inches (0.127-0.1524 mm) coated).

The multi-strand cable is coated with insulation, wherein the entire combined multi-strand cable is coated.

The overall coated diameter of the cable is preferably about 0.001 and 0.007 inches, and preferably about 0.005 inches (0.127 mm). The overall uncoated diameter of the cable is about 0.0005 (0.0127 mm) and 0.006 (0.1524 mm), and preferably about 0.003 inches (0.0762 mm).

The coating is of a thickness of about 0.001 inches (0.0254 mm). The coating has a thickness that is preferably between about 0.0001(0.0254 mm) and 0.004 inches(0.1016 mm).

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a sectional elevational view of a user's hearing area to show the anatomy thereof;

FIG. 2 is a sectional elevational view of a user's ear canal showing placement of a dam and mold material as part of the method of the present invention;

FIG. 3 is a perspective view of the form portion used with the preferred method of the present invention;

FIG. 4 is a perspective view illustrating shaping of the form as part of the method of the present invention;

FIG. 5 is a perspective view illustrating a dipping of the form into a vessel carrying material for making the female mold as part of the method of the present invention;

FIG. 6 is a perspective view illustrating a coating of the form with the female mold as part of the method of the present invention;

FIG. 7 is a partial elevational view of the preferred embodiment of the apparatus of the present invention illustrating the mounting member and the plurality of the electronic hearing aid components;

FIG. 7A is a cross-sectional view taken along the line 7A-7A in FIG. 7;

FIG. 7B is a partial view showing the portion indicated in FIG. 7 as 7B;

FIG. 8 is a elevational view of the lateral side of the mounting member taken along lines 8-8 of FIG. 7;

FIG. 9 is a perspective view illustrating the method step of joining the female mold to the mounting member at the medial side thereof;

FIG. 10 is a perspective view of the preferred embodiment of the apparatus of the present invention and showing the method of the present invention after the joining of the female mold and mounting member;

FIG. 11 is a perspective view illustrating the method step of adding filler material to the interior of the female mold and encapsulating electronic hearing aid component portions of the apparatus;

FIG. 12 is a perspective view illustrating removal of the female mold after the filler material has set and encapsulating the electronic hearing aid components;

FIG. 13 is a perspective of the preferred embodiment of the apparatus of the present invention and the method of the present invention illustrating removal of excess plate and tube material from the mounting member;

FIG. 14 is a perspective view of the preferred embodiment of the apparatus of the present invention;

FIG. 15 is an elevational view of the preferred embodiment of the apparatus of the present invention;

FIG. 16 is an end view of the preferred embodiment of the apparatus of the present invention taken along lines 16-16 of FIG. 15;

FIG. 17 is a top view of the preferred embodiment of the apparatus of the present invention taken along lines 17-17 of FIG. 15;

FIG. 18 is a graphical representation of a comparison of real ear occlusion gain for the present invention versus a hard shell, hollow-type instrument;

FIG. 19 is a graphical representation showing a comparison of real ear aided gain obtained before acoustic feedback, comparing the present invention with a hard shell, hollow-type instrument;

FIG. 20 is a perspective view illustrating an alternate method of the present invention, namely the initial step of forming the female mold;

FIGS. 21-22 show the alternate method of the present invention including a heating of the vacuum forming film material;

FIG. 23 is a perspective view of the alternate method of the present invention shown during vacuum forming;

FIG. 24 is a perspective view of the alternate method of the present invention showing the female mold as part of a vacuum formed sheet;

FIG. 25 is a perspective view of the alternate method of the present invention showing removal of the female mold from the vacuum molded sheet;

FIG. 26 is a perspective view of the method of the present invention showing the female mold after forming using the method steps of FIGS. 23-25;

FIG. 27 is a partial perspective view showing a second alternate embodiment of the method of the present invention, showing the coating of the vent tube;

FIG. 28 is a partial perspective view showing a second alternate embodiment of the method of the present invention, showing removal of the mold to provide a soft solid body with contained vent tube and insert;

FIG. 29 is a partial perspective view showing a second alternate embodiment of the method of the present invention, illustrating an insertion of the hearing aid component assembly into the void space that was formed by removal of the insert;

FIG. 30 is a perspective view that illustrates the second alternate embodiment of the method and apparatus of the present invention;

FIG. 31 is a perspective view illustrating the second alternate embodiment of the method and apparatus of the present invention;

FIG. 32 is a perspective view illustrating the second alternate embodiment of the method and apparatus of the present invention;

FIG. 33 is a perspective of a third alternate embodiment of the apparatus of the present invention;

FIG. 34 is a side sectional view of the third alternate embodiment of the apparatus of the present invention;

FIG. 35 is a partial perspective view of the third alternate embodiment of the apparatus of the present invention;

FIG. 36 is a sectional view taken along lines 36-36 of FIG. 35;

FIG. 37 is an enlarged fragmentary view of the wire sectional diagram of FIG. 36;

FIG. 38 is a top view showing a completed sub assembly;

FIG. 39 is a top view showing a face plate pre-assembly;

FIG. 40 is a side perspective view showing a face plate pre-assembly;

FIG. 41 is a rear view showing a receiver part of the present invention;

FIG. 42 is a top view showing the receiver part of the present invention;

FIG. 43 is a schematic view of a receiver assembly with receiver tube, silicon bead and receiver sleeve in place;

FIG. 44 is a fragmentary view illustrating the construction of wires that are used as part of the present invention;

FIG. 45 is a cut away view showing the microphone pre-assembly;

FIG. 46 is a top view showing the microphone pre-assembly; and

FIG. 47 is a sectional view illustrating the placement of individual wire strands that are part of the multi-strand wire that is used with the present invention.

### DETAILED DESCRIPTION OF THE INVENTION

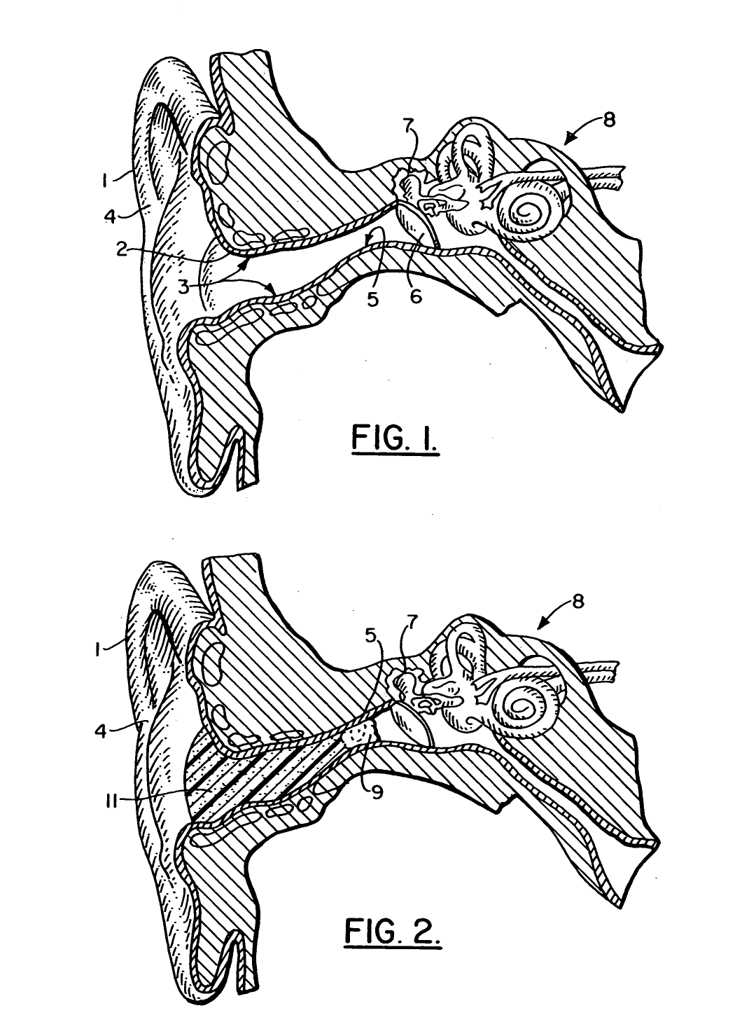

FIGS. 1 and 2 show a user's ear 1 and anatomical parts of the ear. In FIG. 1 there can be seen the external auditory canal 2, ear canal wall 3, auricle 4, isthmus 5, tympanic membrane 6, middle ear 7 and inner ear 8. In FIG. 2 a dam 9 such as a cotton dam or otoblock dam is positioned at the isthmus 5. The dam 9 is used as a first step of the preferred method of the present invention wherein a form portion 11 or impression material is formed of silicone, methylmethacrylate or alginate. The form 11 is formed in between dam 9 and auricle 4 as shown in FIG. 2.

During the method step of making form 11, the form 11 conforms to all of the curvatures of the ear canal 3 so that an accurate form 11 is provided for making a female mold.

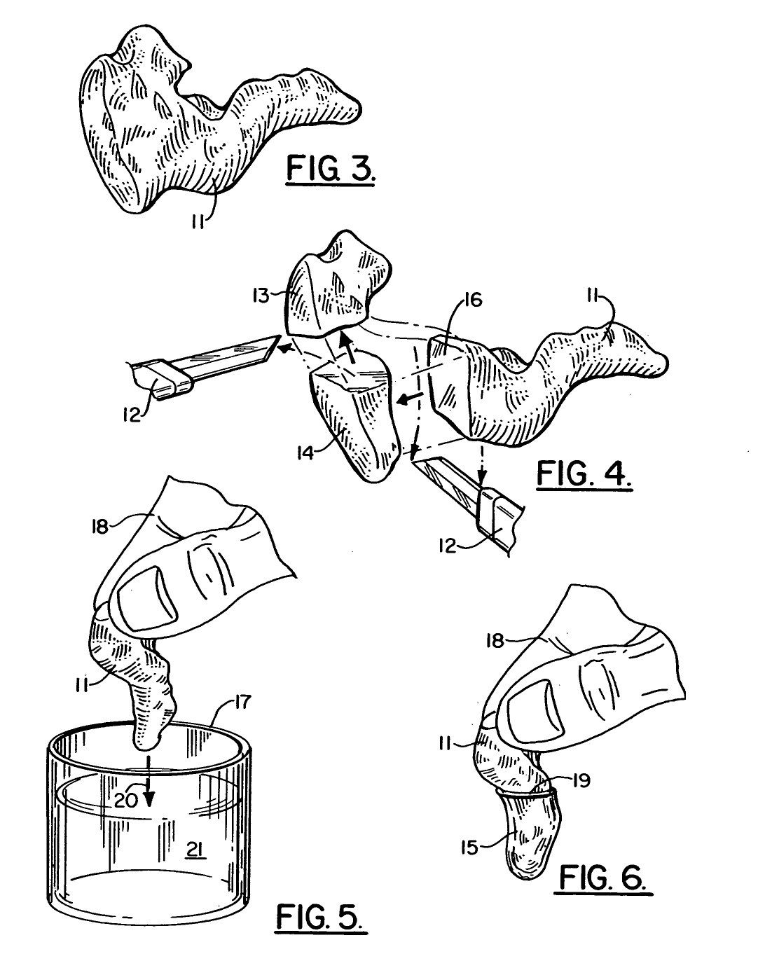

The female mold 15 is shown in FIGS. 6 and 9-12. In FIGS. 3 and 4, the form 11 is shown after being removed from the ear 1 (FIG. 3) and during a cutting of the form 11 using knives 12 to cut excess material that is designated as 13, 14 in FIG. 4. The form 11 is separated from excess material 13 and 14 at sagittal plane 16. After the form 11 is trimmed in FIG. 4, a technician's hand 18 dips the form 11 into vessel 17 as schematically indicated by the arrow 20. The vessel 17 includes a liquid material 21 that cures at room temperature, such as room temperature curing methacrylate (sold by Esschem). It is preferable to use a clear material 21 in the method step shown in FIG. 5.

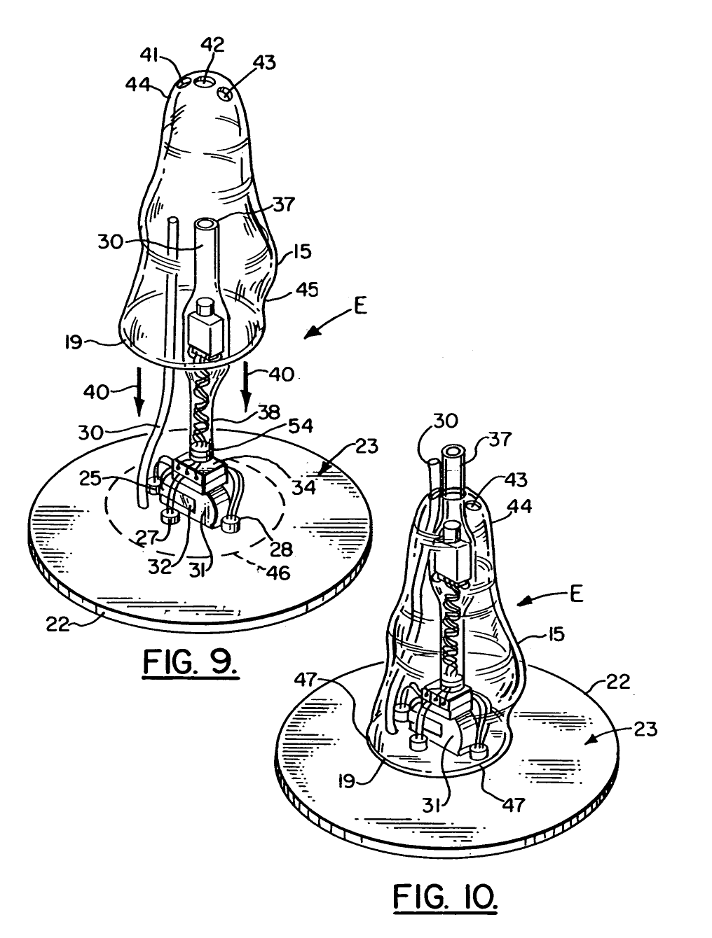

In FIG. 6, the technician's hand 18 has removed the form 11 so that a coating of material 21 cures at room temperature (or with an ultraviolet light process) to form female mold 15 on form 1 1. After it cures, the female mold 15 is removed from form 11 for use as shown in FIGS. 9 and 10 during assembly of the apparatus 10 of the present invention. The mold 15 can be a few millimeters in wall thickness (typically 1-3 mm).

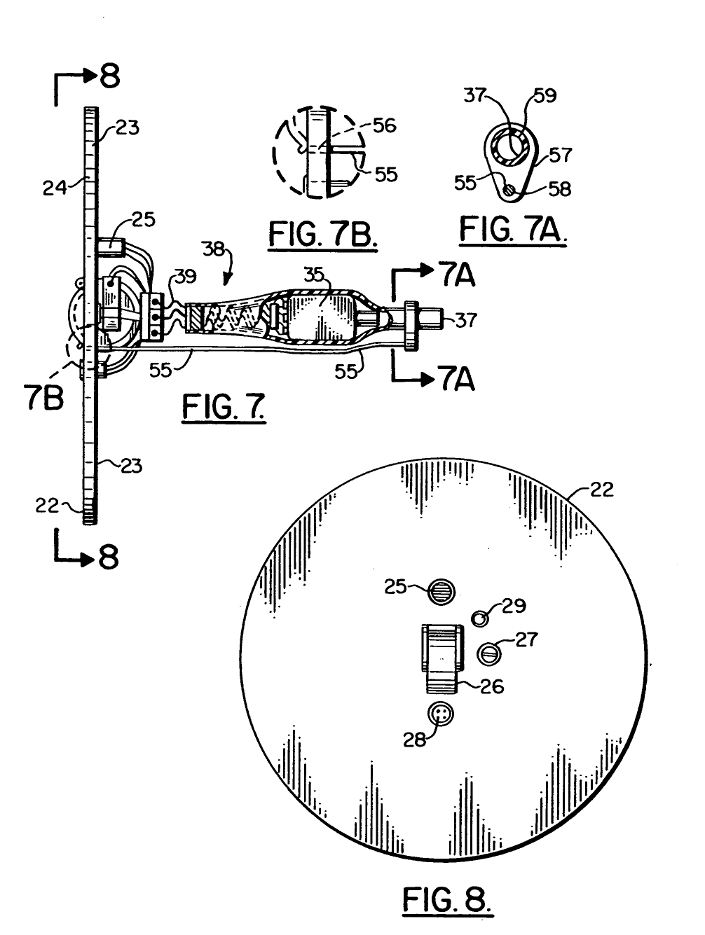

A number of electronic components are mounted to a mounting member 22 prior to use of the female mold 15. Mounting member 22 provides a medial side 23 and lateral side 24. The medial side 23 supports a number of hearing aid electronic components as shown in FIGS. 7, 9, and 10. In FIG. 7, these hearing aid electronic components include commercially available hearing aid components including a microphone 25, volume control, battery, socket or plug 28 for communicating with a computer, chip or micro processor circuit, wiring harness 38, input capacitor, amplifier 34, receiver/speaker 35, and receiver tube 37.

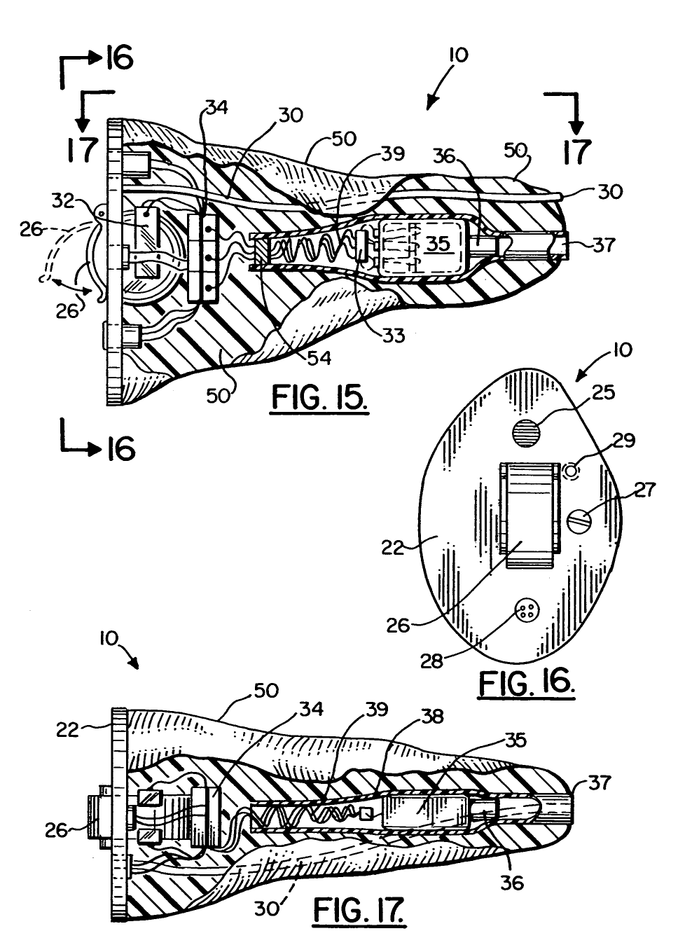

In FIG. 8, the lateral side 24 of mounting member 22 shows the microphone 25, battery compartment 26, volume control 27, programming socket 28 for communicating with a computer, silicone plug 54 (see FIG. 9), and vent opening 29 that communicates with vent tube 30 (see FIG. 10). In FIG. 9, battery 31 is shown housed in battery compartment 26. The electronic hearing aid components also include a battery terminal 32, voltage regulating capacitor 33 (see FIG. 15), amplifier/microprocessor 34, receiver 35 having speaker port 36, and receiver tube 37. A wiring harness 38 includes a plurality of wires that connect to various electronic components of the hearing aid device together. The wiring harness 38 includes a length of wires 39 that are arranged in an S or multiple curved pattern as shown in FIG. 7. This “S loop” configuration of wires 39 helps protect the integrity of the electronics when the hearing aid apparatus 10 is flexed as occurs during use because of its soft nature. Further, the S-loop wires 39 are preferably a 44 gauge five strand Litz wire (or magnet wire). The length of the S-loop wires 39 is preferably at least 1.5 times the distance between the terminals to the receiver (or microprocessor) 35 and the amplifier 34 terminals. These “S-Loop” wires 39 prevent excess tension or compression from being transmitted to the electronics during use (e.g. flexing, elongation, compression of hearing aid 10).

Vent tube 30 is anchored to the mounting member 22 and preferably also to one of the electronic components at a position spaced away from the mounting member 22. Vent tube 30 acts as a tensile load carrying member that carries tension so that the wiring harness 38 is substantially free of a tensile load that could damage the wiring harness 38. Also, when vent tube 30 is anchored to one of the electronic components (such as receiver 35) at a position spaced away from the mounting member 22, it may provide enough strain relief that it would not be necessary to coil wires 39 as shown (they could be straight instead).

Something else could be used as a load carrying member, in place of vent tube 30 (in which case vent tube 30 would not necessarily be anchored to one of the electronic components (such as receiver 35)) at a position spaced away from the mounting member 22. For example, a monofilament cantilever 55 can be used to carry tension so that tension is not transmitted to wiring harness 38. In FIGS. 7, 7A, and 7B the link 55 is anchored to plate 22 at opening 56. Fastener 57 affixes to receiver tube 37 at large opening 59. Monofilament cantilever 55 attaches to fastener 57 at smaller diameter opening 58. Alternatively, vent tube 30 could be manufactured of a tensile material that carries tensile load. The vent tube 30 would then be anchored to plate 22 and fastener 57 as the tensile member.

The monofilament cantilever 55 provides longitudinal stability to the body. It minimizes longitudinal displacement (stretching as well as compression) and thus acts as a longitudinal stabilizer (a longitudinal load carrying member).

After the electronic components (sometimes designated generally in the drawings by the letter “E”) are assembled to the medial 23 side of mounting member 22, female mold 15 is used to complete the method of construction of the present invention as shown in FIGS. 9-13. In FIG. 9, the female mold 15 is placed over the electronic components “E” beginning with the distal end portion of receiver tube 37 and the distal end portion of vent tube 30 as indicated by arrows 40 in FIG. 9. A plurality of three openings 41, 42, 43 are provided at distal end 44 of female mold 15 as shown in FIG. 9. The proximal end 45 of female mold 15 provides an annular edge surface 19 that engages the medial 23 side of mounting member 22 as indicated by the dotted line 46 in FIG. 9.

A joint is formed between annular edge surface 19 of female mold 15 and medial surface 23 of mounting member 22 at a position schematically indicated as dotted line 46 in FIG. 9, using the method of the present invention. The medial surface 23 of mounting member 22 is cleaned with a suitable solvent. Acetone can be used as a solvent in the case of a mounting plate 22 that is made of acrylic. The medial surface 23 of mounting member 22 is then painted with a primer using a swab or brush. The primer is allowed to dry. A bonding agent is then applied to the medial surface 23 of mounting member 22 and allowed to dry. The bonding agent or bonding enhancer can be product A-320 of Factor II, Inc. of Lakeside, Ariz., which is a member of the chemical family “silicone primer”.

The female mold 15 is placed against the medial side 23 of mounting member 22. A liquid acrylic is used to form an acrylic seam at the interface of annular edge surface 19 of female mold 15 and the medial side 23 of mounting member 22 (see FIG. 10). As the female mold 15 is assembled to mounting member 22, vent tube 30 passes through opening 41. Receiver tube 37 passes through opening 42. The opening 43 is then used for injection of filler material 50 (e.g. via needle 49) as shown by arrows 51, 52 in FIG. 11. During this process, temporary seal 47 holds the liquid filler material 50 within the interior 53 that is formed by female mold 15 and mounting member 22. The filler material 50 can be a liquid during the injection step of FIG. 11 so that it encapsulates at least the receiver/speaker electronic component 35 and preferably other components as well.

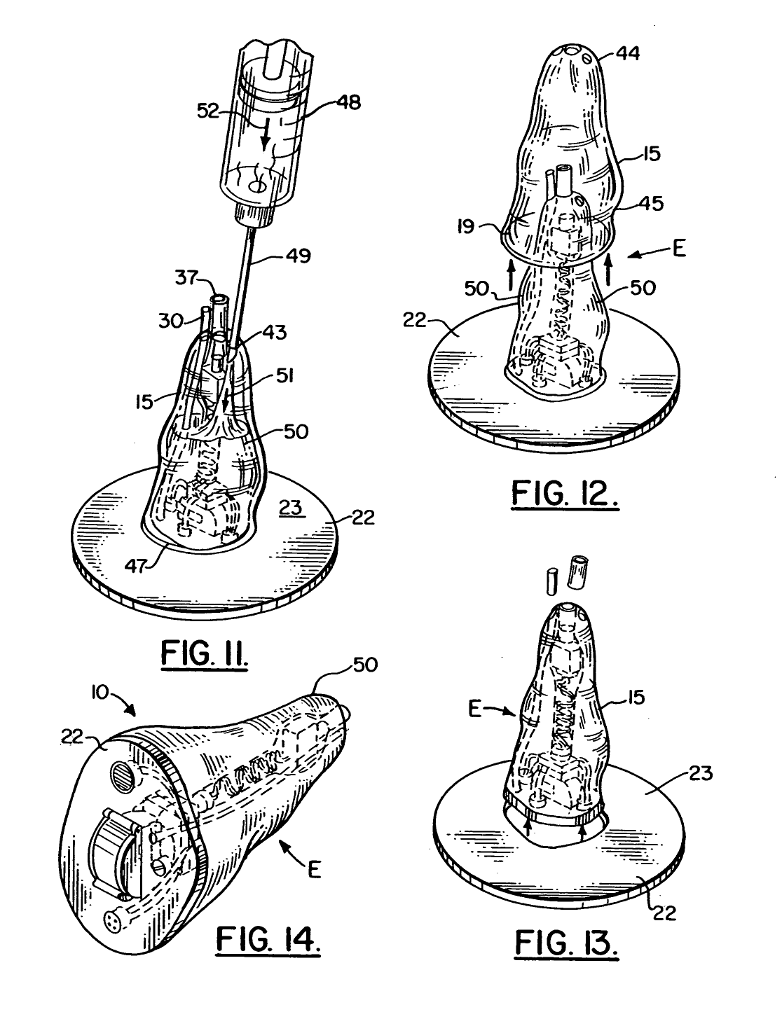

In FIG. 12, the female mold 15 is removed after the material 50 has set. The mounting member 22 (which can be in the form of a circular, generally flat face plate) is then cut at the phantom line 46 that basically tracks the periphery of female mold 15 at annular edge surface 19 at proximal end 45 thereof. This cutting of the unused, unneeded part of mounting member 22 is shown in FIG. 13. FIGS. 14-17 show the completed apparatus 10 of the present invention.

The present invention provides a soft, yet solid hearing aid instrument that will provide a more appropriate environment for both the high fidelity performance of today's advanced circuitry and the dynamic ear canal.

The present invention teaches a soft construction of at least the distal portion of the apparatus 10 so that at least the receiver/speaker is encapsulated with the soft material 50. This construction results in a precise representation of the human ear canal, flex with jaw motion, and cushion for the embedded electronic components “E”.

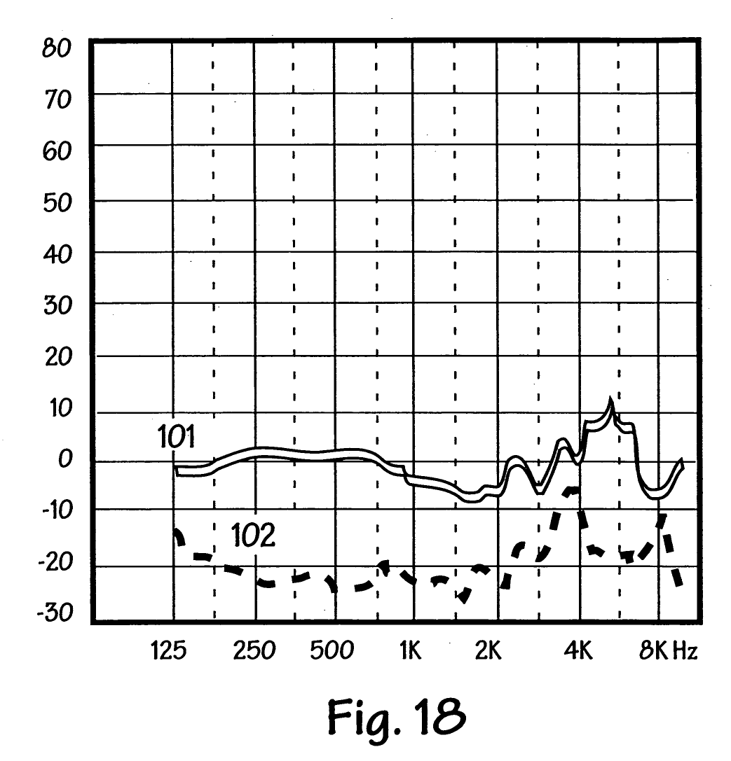

FIG. 18 demonstrates real ear occlusion gain (REOG) finding obtained from a wearer having a tortuous ear canal. The curve 101 represents the REOG of a hard shell, hollow type hearing aid instrument. The curve 102 represents the REOG of an instrument 10 made according to the method of the present invention. As can be seen in FIG. 18, the present invention instrument provided 20 dB more attenuation than did the hard shell, hollow hearing aid instrument represented by the curve 101. Because of the sharp first directional bend of the wearer's ear canal, the hard shell instrument could not be inserted without modification. The apparatus 10 of the present invention was insertable without modification thereby yielding a tighter seal in the wearer's ear.

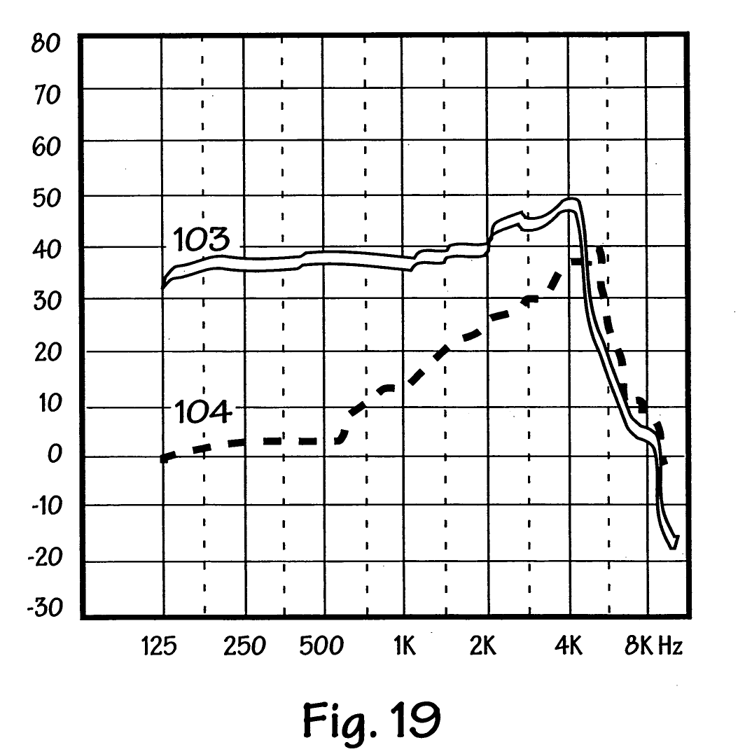

FIG. 19 is a graphical representation that demonstrates real ear aided gain (REAG) findings obtained from a wearer having a tortuous ear canal. The curves shown (103, 104) were obtained from the instruments used to generate the finding shown in FIG. 18. Curve 103 represent REAG before feedback of the apparatus 10 of the present invention. Curve 104 demonstrates the REAG before feedback of a hard shell, hollow type hearing aid instrument of the prior art. As can be seen in FIG. 19, the instrument 10 of the present invention represented by curve 103 provided more gain across the frequencies. This REAG is inversely proportional to the amount of occlusion gain (REOG) or attenuation provided by the apparatus 10 of the present invention. It should be restated that, because of the sharp first directional bend of the wearer's ear canal, the hard shell, hollow type instrument of the prior art could not be inserted without being modified. The apparatus 10 of the present invention was insertable without modification, thus the present invention provides higher added gain values (REAG) when a more negative REOG can be achieved while maintaining comfort.

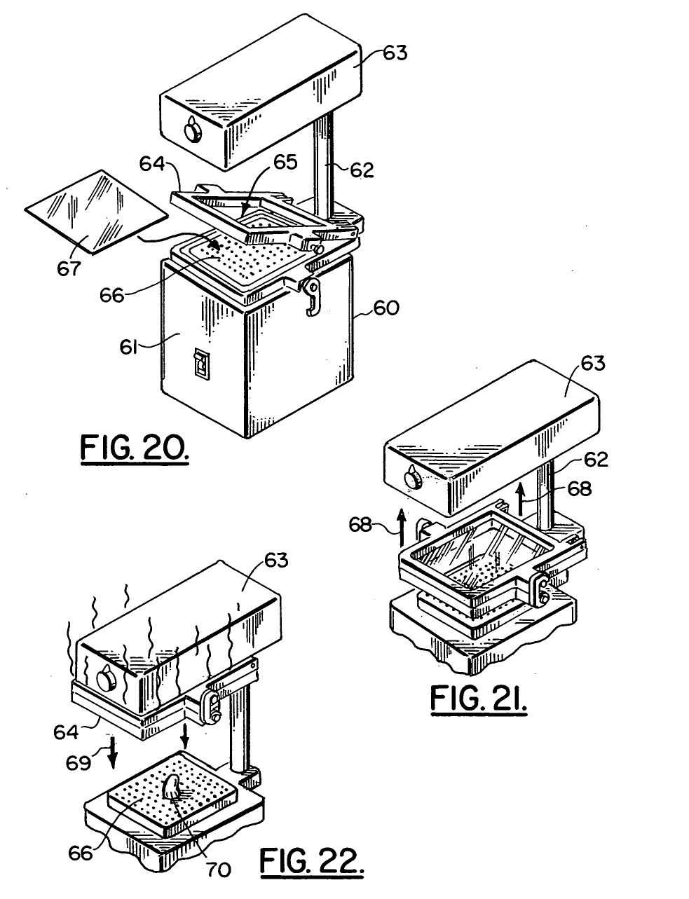

FIGS. 20-25 show an alternate method for forming the female mold that is then used with the preferred embodiment of FIGS. 1-19. The female mold is designated generally by the numeral 15A in FIG. 26 after forming and using the method steps shown in FIGS. 20-25. In FIG. 20, a vacuum mold apparatus 60 has a base 61 that supports a post 62 and heating element 63. Base 61 contains a vacuum pump. Frame 64 can be pivotally mounted to base 61 at post 62. Frame 64 provides opening 65.

A matrix 66 of small openings is provided at the upper portion of base 61. Matrix 66 of openings communicates with the vacuum pump in base 61. In FIG. 21, the sheet of film material 67 is placed into and raised with frame 64 as indicated by arrows 68 in FIG. 21. In FIG. 22, the sheet of film material 67 is heated by heating element 63 as frame 64 engages or is positioned closely to the heating element 63.

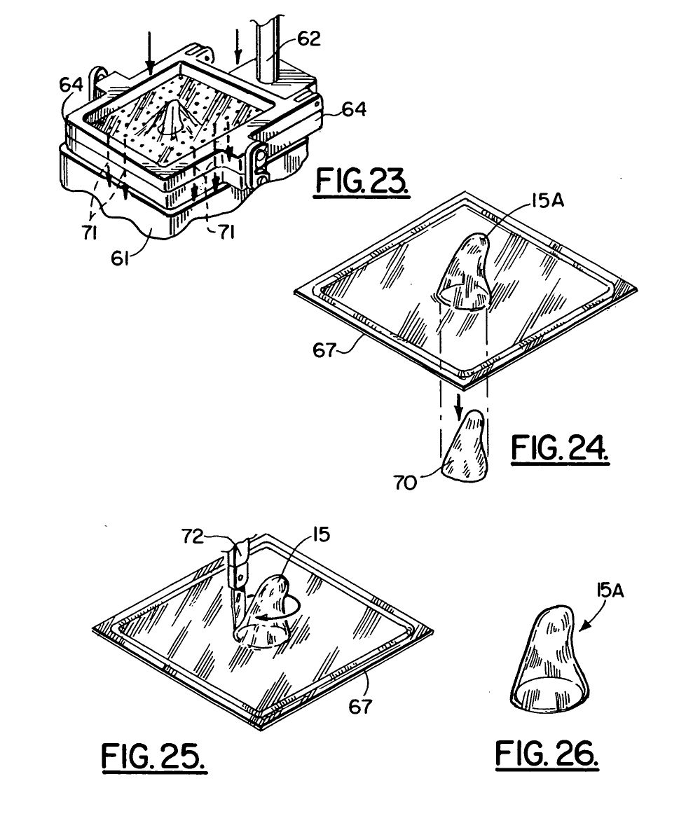

Arrows 69 indicate that frame 64 is lowered after heating element 63 heats sheet of film material 67 (FIG. 22). Male mold 70 is placed upon matrix 66 so that when the heated and softened sheet of film material 67 is lowered with frame 64, the sheet of film material 67 deforms and conforms to the male mold 70 as shown in FIGS. 23 and 24.

A vacuum is drawn through the matrix of opening 66 using the vacuum pump in base 61 as indicated by the arrows 71 in FIG. 23. When the vacuum is discontinued, the male mold 70 is withdrawn, and the female mold 15A is formed as part of sheet 67 as shown in FIGS. 24 and 25. The female mold 15A can then be removed using knife 72. FIG. 26 shows the completed female mold 15A.

It should be understood that the female mold 15A can be used in place of the female mold 15 in the preferred embodiment of FIGS. 1-19 and in the preferred method of FIGS. 1-19.

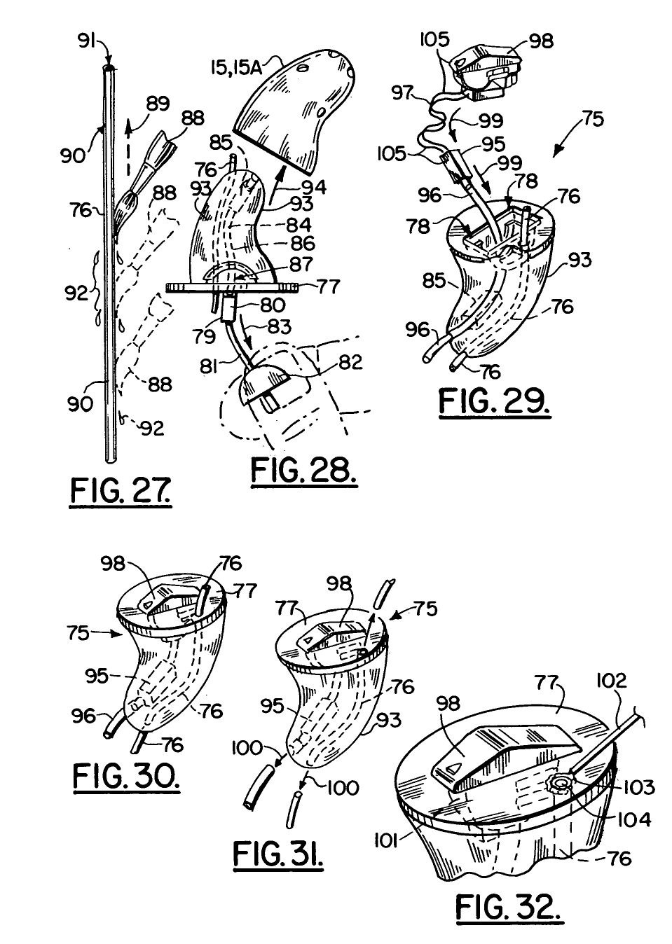

FIGS. 27-32 show a second alternate embodiment of the apparatus of the present invention, and illustrate the second alternate embodiment of the method of the present invention. In FIGS. 27-32, a second, alternate embodiment of the apparatus of the present invention is shown, designated generally by the numeral 75 in FIGS. 29, 30 and 31. Hearing aid 75 is constructed using the method shown in FIGS. 27-32. In FIG. 27, vent tube 76 is shown prior to attachment to mounting member (e.g., acrylic) 77. The mounting member 77 has an opening 78. It should be understood that the mounting member 77 can receive any of the female molds 15, 15A shown in the embodiments of FIGS. 1-26.

An insert 79 includes several sections designed to simulate portions of a hearing aid component assembly 105. For example, the insert 79 can include a section 80 designed to simulate an electronic hearing aid component, namely a receiver. The insert section 81 is designed to simulate a wiring harness. The insert section 82 is designed to simulate a battery compartment or battery receptacle.

Once the selected mold such as 15, 15A is attached to mounting member 77, it can be filled with a polymeric material (preferably silicone), such as is shown in FIG. 11. However, in the embodiment of FIGS. 27-32, vent tube 76 is first coated with a bonding agent 149 such as A330 available from Factor II of Lakeside, Ariz. The vent tube 76 is then placed inside the mold cavity 15, 15A. The mold 15, 15A is then attached (bonded) to mounting member 77 as shown and described with respect to the embodiments of FIGS. 1-26 (see FIG. 11). Once the polymeric material has cured inside mold cavity, the mold 15, 15A can be removed as indicated schematically by arrow 94. A technician then removes insert 78 as indicated schematically by the arrow 83 in FIG. 28. The insert 79 includes an insert section 80 that simulates a receiver, an insert section 81 that simulates a wiring harness and an insert section 82 that simulates a battery compartment or battery receptacle. However, other shapes can be used for insert 136 so that a cavity 141 of desired shape is achieved. Upon removal of the insert 79, a cavity 84 is left behind, the cavity 84 being positioned next to vent tube 76 as shown in FIG. 28.

The cavity 84 simulates the sections of the provided insert 79, including a cavity section 85 that simulates a receiver, a cavity section 86 that simulates a wiring harness and a cavity section 87 that simulates a battery case or receptacle.

The bonding enhancer 92 can be applied to vent tube 76 using a spray or brush 88 as shown in FIG. 27 as indicated schematically by the arrow 89. Vent tube 76 thus has an outer surface 90 that becomes coated with the bonding enhancer or bonding agent 92. Vent tube 76 provides a bore 91 which is not coated with the bonding enhancer, as it remains open to vent air flow in between the patient's ear canal and the exterior of the ear canal and hearing aid 75.

The polymeric filler material 93 that is added to mold 15, 15A cavity forms a soft and solid body having the provided cavity 84 into which a hearing aid component assembly 105 can be inserted, as indicated schematically by arrows 99 in FIG. 29. This hearing aid component assembly can include both electronic hearing aid components and other components. As an example, in FIG. 29, the hearing aid component assembly 105 includes a receiver 95, receiver tube 96, wiring harness 97, and a battery compartment 98 that includes other hearing aid components such as battery 101, a microphone, an amplifier, or other desired hearing aid components.

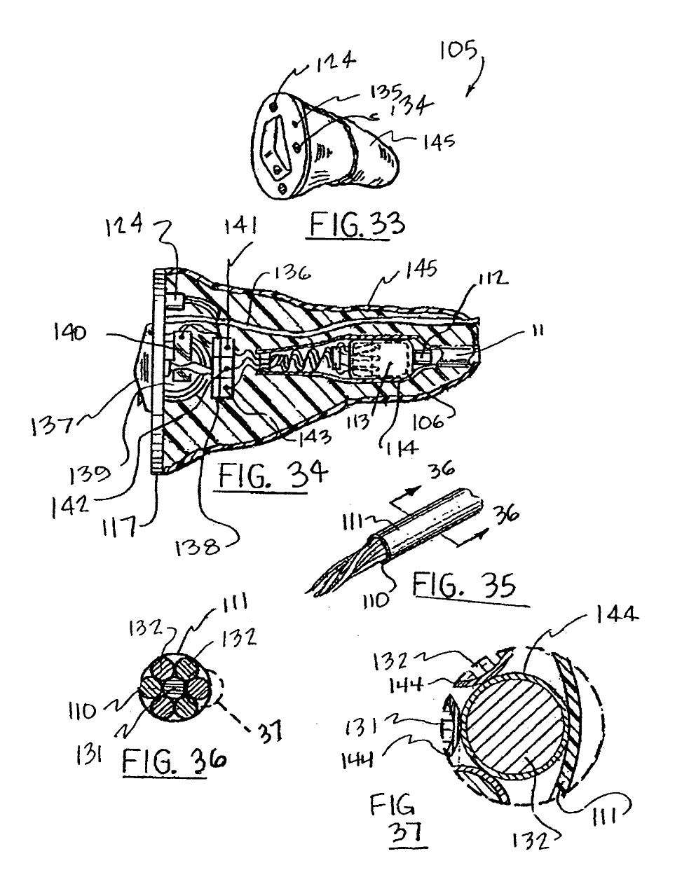

FIGS. 29-31 illustrate the completion of and insertion of hearing aid component assembly 105 into the cavity 84 that was formed after the polymeric filler material 93 had cured and set, and after which the shaped insert 79 had been removed. In FIG. 31, arrows 100 schematically indicate a severing of excess vent tube 76 material and the severance of excess material from receiver tube 96. The receiver tube 96 and vent tube 76 communicate with the patient's inner ear generally opposite mounting member 77 as shown in FIGS. 28-31. The vent tube 76 also communicates with the exterior of the patient's ear via an opening 104 in mounting member 77 (see FIG. 32). A connection 103 can be formed between vent tube 76 and mounting member 77 using a needle 102 to apply an adhesive or other connection material or structure, for example.

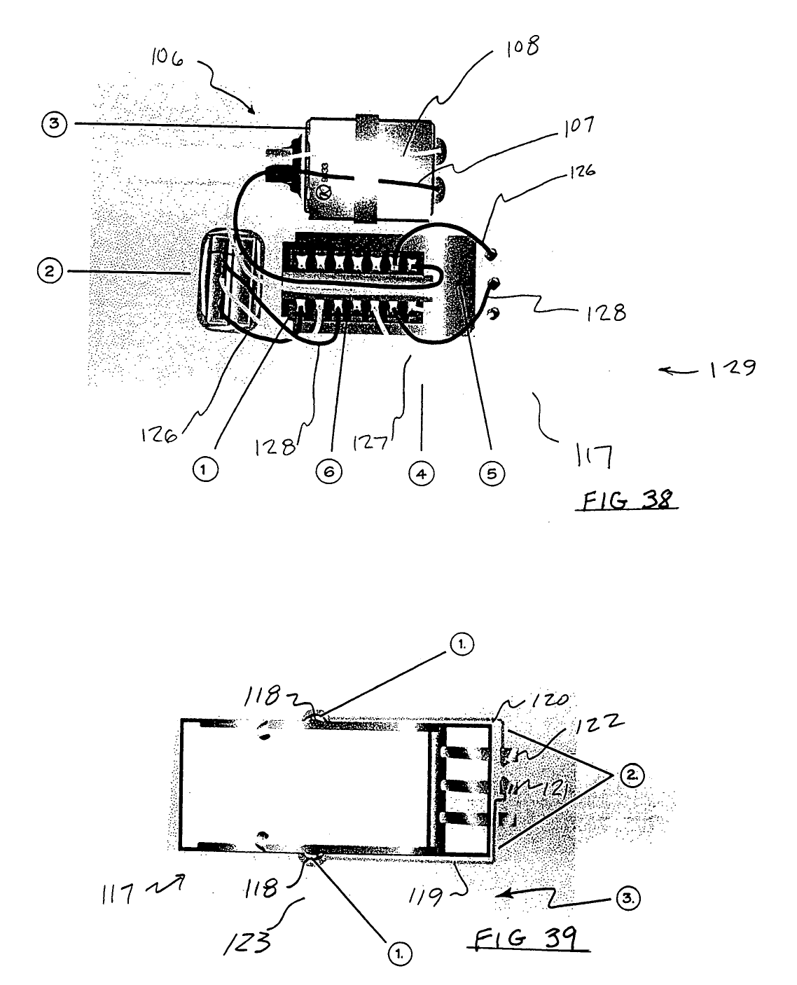

In FIGS. 33-37, a third alternate embodiment of the apparatus of the present invention is shown, designated generally by the numeral 105. Hearing aid 105 has various components embedded in a soft, solid polymeric (preferably silicone) body 133. In FIGS. 42-44, receiver assembly 106 is shown that includes a receiver 113 to which is attached.

In FIGS. 33 and 34, a shell 145 (of polymeric or elastomeric material, for example, such as polyvinyl or silicone having a different (higher) durometer than the fill material) can be connected to face plate 117 and then filled with silicone material or other suitable polymeric filler to form a body that is soft and solid, preferably having a softness as was described with respect to the preferred embodiments of FIGS. 1-32. In the embodiment of FIGS. 33 and 34, the shell 145 can remain a part of the hearing aid 105. In such a case, the shell 145 is preferably of a soft material such as silicone or other soft polymer having a hardness of about 40 durometers Shore A.

Hearing aid 105 is otherwise similar to the embodiments of FIGS. 1-33, providing a soft solid body 133 attached to face plate 117. The face plate 117 can be provided with a volume control 134, vent 135, and microphone 134. Vent tube 136 is connected to vent opening 135 and extends the full length of the hearing aid 105 as shown in FIG. 34.

A battery cover 137 opens to reveal a socket that holds battery 139 and battery contact 140.

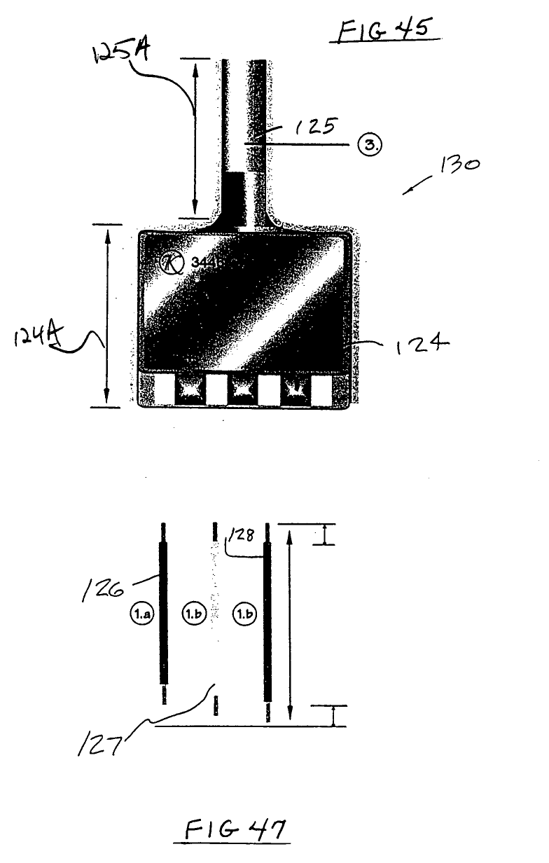

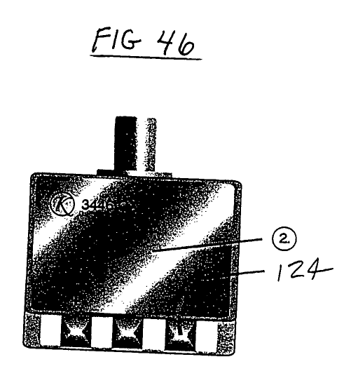

Amplifier 138 provides ground 141, signal 142 and power 143 contacts to which wiring can be connected as shown in FIGS. 34 and 38-47.

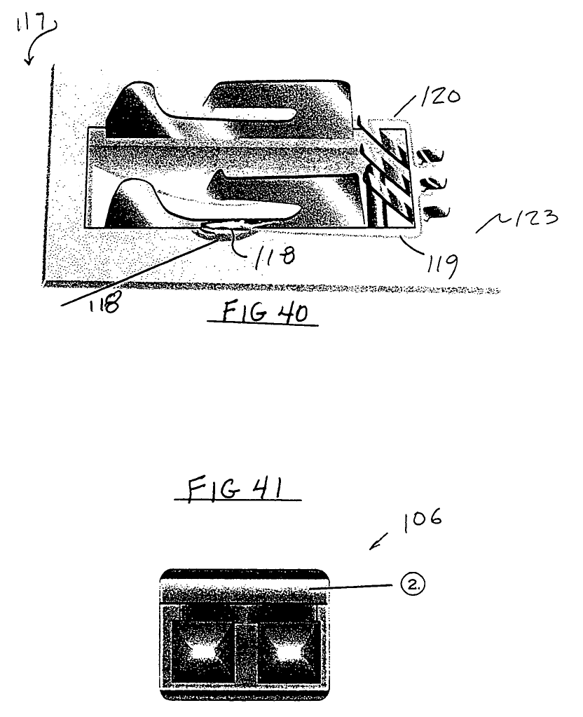

In FIGS. 36 and 37, each of the wires that are part of the wiring harness or other wiring for the apparatus 105 can be a multi-strand (for example, seven strand) cable 110 having an insulative coating 111. In FIGS. 35-37, each wire 131, 132 can have a plating 144. The multi-strand cable can be insulated with an insulative coating 111.

In FIGS. 42-44, wire 107 is a power wire. The wire 108 is a signal wire. Each wire 107, 108 is preferably of a multi-strand cable 110 (see FIG. 43) that is covered with an insulation or other bio-compatible insulated coating 111. In FIGS. 41-43, the circled numbers denote the following: (1) 1.a—red (power), 1.b—yellow(signal), 1.c—green and 0.005 inch 01.127 mm) silver plated, seven strand stainless steel with ETFE coating; (2) receiver: EH-9833; (3) silicone tubing having inner diameter of 0.047 inches (1.19 mm) by 0.095 inches (2.41 mm) and having a hardness of 50 durometer—3.a—silicone receiver port tubing, 3.b—receiver boot tubing, and 3.c—strain relief tubing; (4) silicone beed, preferably NuSil Silicone R-440. Wires 107,108 are preferably 27 millimeters in length and having 1 millimeter strips at either end.

In FIGS. 42-43 a receiver port tube 112 is attached to receiver 113. A receiver boot tubing 114 is positioned about receiver 113. A receiver strain relief tubing 115 encircles receiver 113, boot tubing 114, and wires 107, 108 as shown in FIG. 37. A silicone bead 116 is placed at the intersection of the receiver port tubing 112 and receiver 113. Dimension 112A is preferably a minimum of 35 mm. Dimension 115A is preferably 2 mm. Dimension 114A for the boot length is preferably 6 mm. FIG. 43 shows receiver assembly with receiver tube 112, silicone bead 116, and receiver sleeve 114 in place.

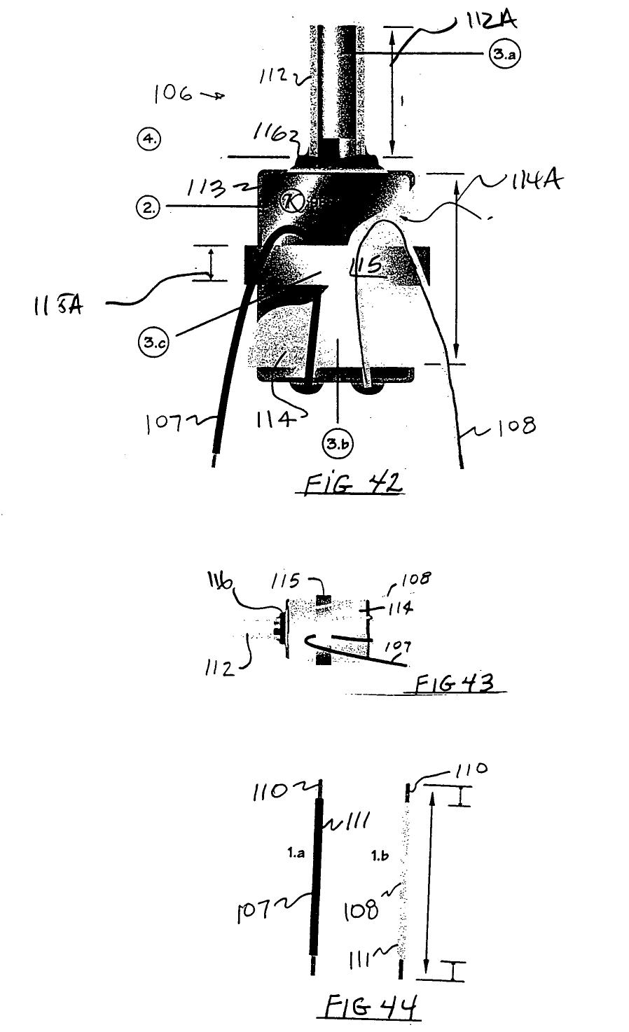

FIGS. 39-40 show a face plate pre-assembly 117 for use with the third alternate embodiment of the present invention. The face plate pre-assembly 117 is shown in the top view of FIG. 39 and in the side perspective view of FIG. 40. A pair of solder resin core (e.g. 60/40) beads 118 are placed on opposing sides of face plate pre-assembly 117 as shown. The face plate can be excavated to accommodate solder beads. Wires 119, 120 extend respectively from the solder resin core beads 118. Wire 119 extends between a wire bead 118 and terminal 121. The wire 120 extends between a bead 118 and terminal 122. The face plate pre-assembly 117 includes a strap interface 123. The solder can be Kester #44 having a rosin core, 60/40. The wire can be 0.003 inches (0.0762 mm) O.D. uncoated, solid silver plated stainless steel. The faceplate can be Intech #10k-1101001005, 10A strap interface.

FIGS. 45-47 show the microphone pre-assembly 130 that includes microphone 124, silicone tubing 125, and wires 126, 127, 128. As with the wires 119, 120 the wires 126, 127, 128 are preferably multi-strand cables 110 such as shown in cross section in FIG. 43 and that are coated with a bio-compatible insulation coating 111. Microphone 124 is shown in a cutaway view of tubing serving as a microphone boot. The bio-compatible insulation coating 111 is preferably selected from the group that includes PTFE, ETFE, or other bio-compatible insulation. FIG. 45 is a cutaway view of MIC EM 3445 CX and FIG. 46 is a top view. Wire 126 is preferably 7 mm in length, is red in color, and denotes power. Wire 127 is preferably 8 mm in length, is yellow in color and denotes signal. Wire 128 is preferably 9.5 mm in length, is green in color and denotes ground. Each wire 126,127,128 preferably have a 1 mm strip at either end and are preferably 0.005 inches(0.127 mm) silver plated, seven strand stainless steel with an ETFE coating. Dimension 125A is preferably 15 mm. Dimension 124A of the microphone boot tube section is preferably 4 mm. Silicone tubing 125 has preferably 0.047 inch (1.19 mm) inner diameter by 0.095 inch (2.41 mm) outer diameter and a hardness of 50 durometers. Tubing 125 section can serve as a microphone port.

The individual strands 132 of the cable 110 as shown in FIG. 36 can be of stainless steel and plated with a material that enables the cables 110 to be soldered. Plating 144 can be gold or silver or copper flashing as examples. The wire 126 is a power wire. The wire 127 is a signal wire. The wire 128 is a ground wire.

The completed sub-assembly 129 is shown in FIG. 38. The completed sub-assembly 129 includes the microphone pre-assembly 130 of FIGS. 41-42, the receiver assembly 106 of FIGS. 37-39, and the face plate pre-assembly 117 of FIGS. 34-35. In the diagram of FIG. 33, the wires 107 and 126 are power wires. The wires 108 and 127 are signal wires. The wires 128 are ground wires. The circled numbers in FIG. 38 are as follows: (1) Etymotic ER51 hybrid; (2) microphone pre-assembly; (3) receiver pre-assembly; (4) faceplate Intech #10k-1101001005; (5) hard 10A boot Intech #11A-1103007002; and (6) silicone wiring tube having inner diameter 0.019×outer diameter 0.039 and 50 durometer.

In FIG. 36, the multi-strand cable 110 that can be used for any of the wires 107, 108, 126, 127, 128 is shown in transverse cross-section as including a center wire 131 and six peripheral wires that extend around the wire 131, the six peripheral wires being each designated by the numeral 132. Such a cable 110 is preferably about 0.003 in (0.0762 mm) uncoated condition of FIG. 36 and is preferably about 0.005 inches (0.127 mm) in diameter once coated with insulation. Cable 110 can be obtained from Fort Wayne Metals (www.fortwaynemetals.com).

It should be understood that the wire that is shown and described in FIG. 36 and that has been specified as wires 107, 108, 126, 127, 128 is a multi-strand stainless steel, plated and/or insulated cable that can be soldered and that can be used to replace the wire for the harnesses shown in any of the embodiments of FIGS. 1-32 such as, for example, the wiring harness 38 or 97.

The apparatus 10 of the present invention will result in a better utilization of advanced circuitry and a more comfortable hearing instrument. The soft construction solves the problem of peripheral leakage, poor fit, and pivotal displacement that often occurs with jaw motion.

Another problem that is solved with the present invention is the elimination of internal cross-talk of components housed in hollow shell type hearing aids.

The following table lists the parts numbers and parts descriptions as used herein and in the drawings attached hereto.

### Parts List

Part Number Description

1 ear

2 external auditory canal

3 ear canal wall

4 auricle

5 isthmus

6 tympanic membrane

7 middle ear

8 inner ear

9 dam

10 hearing aid

11 form

12 knife

13 excess material

14 excess material

15 female mold

15A female mold

16 sagittal plane

17 vessel

18 technician's fingers

19 annular surface

20 arrow

21 mold material

22 mounting member

23 medial side

24 lateral side

25 microphone

26 battery compartment

27 volume control

28 programming socket

29 vent opening

30 vent tube

31 battery

32 battery terminal

33 voltage regulating capacitor

34 amplifier/microprocessor

35 receiver

36 receiver port

37 receiver tube

38 wiring harness

39 s-loop wires

40 arrow

41 opening

42 opening

43 opening

44 distal end

45 proximal end

46 dotted line

47 temporary seal

48 syringe

49 needle

50 filler material

51 arrow

52 arrow

53 interior space

54 silicone plug

55 monofilament cantilever

56 opening

57 fastener

58 small opening

59 large opening

60 vacuum mold

61 base

62 post

63 heating element

64 frame

65 opening

66 matrix

67 sheet of film material

68 arrow

69 arrow

70 male mold

71 arrow

72 knife

75 hearing aid

76 vent tube

77 mounting member

78 opening

79 insert

80 insert section

81 insert section

82 insert section

83 arrow

84 cavity

85 cavity section

86 cavity section

87 cavity section

88 brush

89 arrow

90 outer surface

91 bore

92 bonding agent

93 filler material

94 arrow

95 receiver

96 receiver tube

97 wiring harness

98 battery compartment

99 arrow

100 arrow

101 battery

102 needle

103 connection

104 opening

105 hearing aid

106 receiver assembly

107 wire

108 wire

110 multi-strand cable

111 coating

112 receiver port tubing

113 receiver

114 receiver boot tubing

115 receiver strain relief tubing

116 silicone bead

117 face plate pre assembly

118 resin core solder bead

119 wire

120 wire

121 terminal

122 terminal

123 strap interface

124 microphone

125 tubing

126 wire

127 wire

128 wire

129 sub assembly

130 microphone pre assembly

131 central wire

132 peripheral wire

133 body

134 volume control

135 vent

136 vent tube

137 battery cover

138 amplifier

139 battery

140 battery contact

141 ground

142 signal

143 power

144 plating

145 shell

The foregoing embodiments are presented by way of example only; the scope of the present invention is to be limited only by the following claims.

1. A hearing aid adapted for use in the ear canal of a user comprising:
a) a plate member with a plurality of hearing aid components mounted thereto, said components including at least a battery, microphone, amplifier and speaker;
b) a soft polymeric body that is bonded to the plate member and including a supporting interface portion comprised of soft-solid polymeric material that is of sufficient thickness to closely conform to both the ear canal and at least one of the components;
c) the soft polymeric body and components defining a soft structure compliant to the ear canal during use, and that is substantially solid and free of void spaces between at least one of the components and the ear canal;
d) the combination of the soft compliant structure and encapsulated hearing aid component minimizing feedback;
e) the hearing aid components including a wiring harness that interfaces with multiple electronic hearing aid components, said wiring harness being multiple stainless steel wires that form a multi-strand cable of multiple slated stainless steel wires, the cable being coated with a bio-compatible insulation.

2. The hearing aid of claim 1 wherein the plate member has opposing generally flat sides including a medial side and a lateral side, and the hearing aid components are mounted to extend medially from the medial side.

3. The hearing aid of claim 1 wherein the plate member is generally circular in shape.

4. The hearing aid of claim 1 wherein the components include electronic hearing aid components and the plate member carries a number of controls for the electronic components on the lateral side of the plate member.

5. The hearing aid of claim 1 wherein a bonding enhancer forms an interface between the soft polymeric body and the plate member.

6. The hearing aid of claim 1 wherein the soft polymeric body includes silicone.

7. The hearing aid of claim 1 wherein the soft polymeric body includes silicone with a hardness of between 3 and 40 Durometer Shore A.

8. The hearing aid of claim 1 wherein the plate member is acrylic.

9. The hearing aid of claim 7 wherein the plate member is acrylic.

10. The hearing aid of claim 1 wherein the soft polymeric body has a hardness of between about 10 and 35 Durometer Shore A.

11. The hearing aid of claim 1 wherein the soft polymeric body anatomically fits the contours of the ear canal.

12. A hearing aid adapted for use in the ear canal of a user comprising;
a) a mounting member having medial and lateral side portions, the medial side supporting a plurality of hearing aid components;
b) a soft polymeric body is of bondable silicone that is joined to the mounting member and which encapsulates a plurality of the hearing aid components, the body shaped to closely conform the ear canal of a user;
c) the soft polymeric body and encapsulated hearing aid components defining an interface portion comprised of a soft structure compliant to the ear canal during use, the soft polymeric body of sufficient thickness to closely conform to both the ear canal and at least one of the components being;
d) the combination of the soft compliant structure and encapsulated electronic hearing aid components minimizing acoustic leakage; and
e) a wiring harness that links multiple of the components, the harness being a multi-strand stainless steel cable of plated strands and covered with a bio-compatible insulation coating.

13. A hearing aid adapted for use in the ear canal of a user comprising:
a) a plastic mounting member supporting a plurality of connected electronic hearing aid components, the mounting member having medial and lateral surface portions;
b) a soft polymeric body that is bonded to the plastic mounting member medial surface portion, and which encapsulates at least some of the electronic hearing aid components, the body being shaped to conform to the ear canal of a user;
c) the soft polymeric body and encapsulated electronic hearing aid components defining a soft structure compliant to the user's ear canal during use, and that is substantially solid and free of void spaces;
d) wherein the soft polymeric body defines an interface portion of sufficient thickness to closely conform to both the ear canal and one of the components; and
e) a wiring harness that links multiple of the components, the harness being a multi-strand stainless steel cable of multiple plated strands and covered with a bio-compatible insulation coating.

14. The hearing aid of claim 13 wherein the soft polymeric body includes silicone.

15. The hearing aid of claim 13 wherein the soft polymeric body has a hardness of between about 10 and 35 Durometer Shore A.

16. The hearing aid of claim 1 wherein the mounting member is acrylic.

17. The hearing aid of claim 1 further comprising a wiring harness that interconnects some of the electronic components and a load carrying member for preventing at least some transfer of tensile load to the wiring harness.

18. The hearing aid of claim 17 wherein the load carrying member provides longitudinal stability.

19. The hearing aid of claim 18 wherein the load carrying member is the vent tube.

20. The hearing aid of claim 13 wherein the electronic components include a multiple S-loop wiring harness.

21. The hearing aid of claim 13, sized to fit completely in the ear canal of the user.

22. The hearing aid of claim 1, sized to fit completely in the ear canal of the user.

23. The hearing aid of claim 12, sized to fit completely in the ear canal of the user.

24. The hearing aid of claims 1, 12 or 13 wherein the overall diameter of the coated wire cable is about 0.13 millimeters.

25. The hearing aid of claims 1, 12 or 13 wherein the uncoated diameter of the multi-strand cable is about 0.08 millimeters.

26. The hearing aid of claims 1, 12 or 13 wherein the overall coated diameter is between about 0.025 millimeters and 0.18 millimeters for the multi-stranded cable.

27. The hearing aid of claims 1, 12 or 13 wherein the overall uncoated diameter of the multi-strand cable is between about 0.013 and 0.025 millimeters.

28. The hearing aid of claims 1, 12 or 13 wherein the coating has a thickness of about 0.001 inches.

29. The hearing aid of claims 1, 12 or 13 wherein the coating has a thickness of between about 0.0001 and 0.004 inches.

30. The hearing aid of claims 1, 12 or 13 wherein the strands of the multi-strand cable are coated with silver.

31. The hearing aid of claims 1, 12 or 13 wherein the strands of the multi-strand cable are coated with gold.

32. The hearing aid of claims 1, 12 or 13 wherein the strands of the multi-strand able are plated with a plating that enables the wire to be soldered.

33. The hearing aid of claims 1, 12 or 13 wherein the coating material is a bio-compatible coating selected from the group that includes teflon, ETFE and PTFE.

34. The hearing aid of claims 1, 12 or 13 wherein the plating is a copper flash coating.

35. The hearing aid of claims 1, 12 or 13 wherein the individual wires of the multi-strand wire are each plated.

36. The hearing aid of claims 1, 12 or 13 wherein the overall multi-strand wire is coated with insulation.

37. (canceled)
